(19) United States
(12) Patent Application Publication
(10) Pub. No.: US 2016/0210921 A1
(43) Pub. Date: Jul. 21, 2016

(54) DISPLAY APPARATUS AND DRIVING METHOD THEREOF

(71) Applicant: Samsung Display Co., LTD., Yongin-si (KR)

(72) Inventors: Sehuhn HUR, Yongin-si (KR); Gyuhyeon KIM, Suwon-si (KR)

(21) Appl. No.: 14/980,978

(22) Filed: Dec. 28, 2015

(30) Foreign Application Priority Data
Jan. 21, 2015 (KR) 10-2015-0010216

(51) Int. Cl. G09G 3/36; H04N 13/04

(52) U.S. Cl. CPC G09G 3/3648; H04N 13/0497; G09G 2310/08; G09G 2300/0439

(57) ABSTRACT

A display apparatus, which allocates a first data to first gate lines, and allocates a second data to second gate lines subsequent to the first gate lines, includes a display panel including pixels disposed on respective intersections, a gate driver which turns on the first gate line and the second gate line in response to a gate control signal, a data driver which transmits a data signal to the data lines in response to a data and a data control signal, and a timing controller which generates the gate control signal such that a turn-on time of at least one first gate line of the first gate lines is shifted by a predetermined shift time, and provides the data and the data control signal such that a combined data of the first and second data is provided to the pixels connected to the at least one first gate line.

This application claims priority to Korean Patent Application No. 10-2015-0010216, filed on Jan. 21, 2015, and all the benefits accruing therefrom under 35 U.S.C. §119, the content in its entirety is herein incorporated by reference.

### BACKGROUND

1. Field

The invention herein relates to a liquid crystal display apparatus, and more particularly to, a display apparatus capable of removing aliasing observed in an image.

2. Description of the Related Art

Typical display apparatuses express colors by using three primary colors, i.e., red, green, and blue. Accordingly, display panels used in typical display apparatuses include red, green, and blue pixels respectively expressing red, green, and blue colors.

Recently, display apparatuses which express colors by using red, green, blue and auxiliary color have been developed. The auxiliary color may be any color, or two or more colors from among magenta, cyan, yellow, and white. Also, in order to improve the brightness of displayed images, display apparatuses including red, green, blue, and white pixels have been developed. Such display apparatuses receive red, green, and blue image signals and convert the image signals into red, green, blue, and white data signals.

The converted red, green, blue, and white data signals are respectively provided to the corresponding red, green, blue, and white pixels. As a result, an image is displayed through red, green, blue, and white pixels.

### SUMMARY

The present disclosure provides a display apparatus capable of improving display quality by solving vertical moving lines and resolution deterioration occurring when displaying three dimensional images, and a driving method thereof.

Exemplary embodiments of the invention provide a display apparatus, which allocates a first data to a plurality of first gate lines, and allocates a second data to a plurality of second gate lines subsequent to the plurality of first gate lines, the display apparatus includes a display panel including a plurality of pixels disposed on respective intersections where the plurality of first gate lines or the plurality of second gate lines cross a plurality of data lines, a gate driver which turns on the plurality of first gate line and the second gate line in response to a gate control signal, a data driver which transmits the data signal to the plurality of data lines in response to a data and a data control signal, and a timing controller which generates the gate control signal such that a turn-on time of at least one first gate line of the plurality of first gate lines is shifted by a predetermined shift time, and provides the data and the data control signal such that a combined data of the first and second data is provided to the pixels connected to the at least one first gate line.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention.

FIG. 1 is a schematic block diagram of a display apparatus according to an exemplary embodiment of the invention;

FIG. 2 is an equivalent circuit diagram of one pixel illustrated in FIG. 1;

FIG. 3 is a view exemplarily illustrating a data interpolation method depending on a shift interval of a gate shift according to the invention;

FIG. 4 is a view illustrating the gate shift method described in FIG. 3;

FIG. 5 is a view illustrating another exemplary embodiment of a gate shift method according to the invention;

FIG. 6 is a view illustrating an example of an image interpolation method according to the invention;

FIG. 7 is a view schematically illustrating another exemplary embodiment of a gate shift method and a data interpolation method according to the invention;

FIG. 8 is a view schematically illustrating another exemplary embodiment of a gate shift method and a data interpolation method according to the invention;

FIG. 9 is a view illustrating a data driving method for some pixels of FIG. 8;

FIG. 10 is a view schematically illustrating another exemplary embodiment of a gate shift method and a data interpolation method according to the invention;

FIG. 11 is a view illustrating a data driving method for some pixels of FIG. 10;

FIG. 12 is a view schematically illustrating another exemplary embodiment of a gate shift method and a data interpolation method according to the invention;

FIG. 13 is a view illustrating a data driving method for some pixels of FIG. 12;

FIG. 14 is a view schematically illustrating another exemplary embodiment of a gate shift method and a data interpolation method according to the invention;

FIG. 15 is a view illustrating a data driving method for some pixels of FIG. 14;

FIG. 16 is a view schematically illustrating another exemplary embodiment of a gate shift method and a data interpolation method according to the invention;

FIG. 17 is a view illustrating a data driving method for some pixels of FIG. 16; and

FIG. 18 is a view illustrating effects of the invention.

### DETAILED DESCRIPTION

Advantages and features of the invention, and implementation methods thereof will be clarified through following embodiments described with reference to the accompanying drawings. The invention may, however, be embodied in different forms and should not be construed as limited to the embodiments set forth herein. Rather, these embodiments are provided so that this invention will be thorough and complete, and will fully convey the scope of the invention to those skilled in the art. Further, the invention is only defined by scopes of claims. Like reference numerals refer to like elements throughout.

When it is described that an element or layer is on another element or layer, the element or layer may be directly on the other element or layer or an intermediate element or layer may be in between. On the contrary, when it is described that the element or layer is directly on the other element or layer, there is no intermediate element or layer in between. The term “and/or” includes each of mentioned items and all combinations thereof.

The terms “below”, “beneath”, “lower”, “above” and “upper” representing spatial relativity may be used to easily describe the correlation between an element or component and another element or component as shown in the drawings. The terms representing spatial relativity should be understood as terms including different directions of an element in use or in operation in addition to the direction shown in the drawings. Like reference numerals refer to like elements throughout.

Although the terms “first” and “second” are used to describe various elements, components and/or sections, these elements, components and/or sections are not limited by these terms. These terms are only used to distinguish an element, component or section from another element, component or section. Thus, a first element, component or section mentioned below may also be a second element, component or section within the technical spirit of the invention.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments described in the invention are described with reference to plane views and cross-sectional views that are ideal, schematic diagrams of the invention. Accordingly, shapes of the exemplary views may be modified according to manufacturing techniques and/or allowable errors. Therefore, the embodiments of the invention are not limited to the specific shape illustrated in the exemplary views, but may include other shapes that may be created according to manufacturing processes. Areas exemplified in the drawings have general properties, and are used to illustrate a specific shape of a semiconductor package region. Thus, this should not be construed as limited to the scope of the invention. Hereinafter, exemplary embodiments will be described in detail with reference to the accompanying drawings.

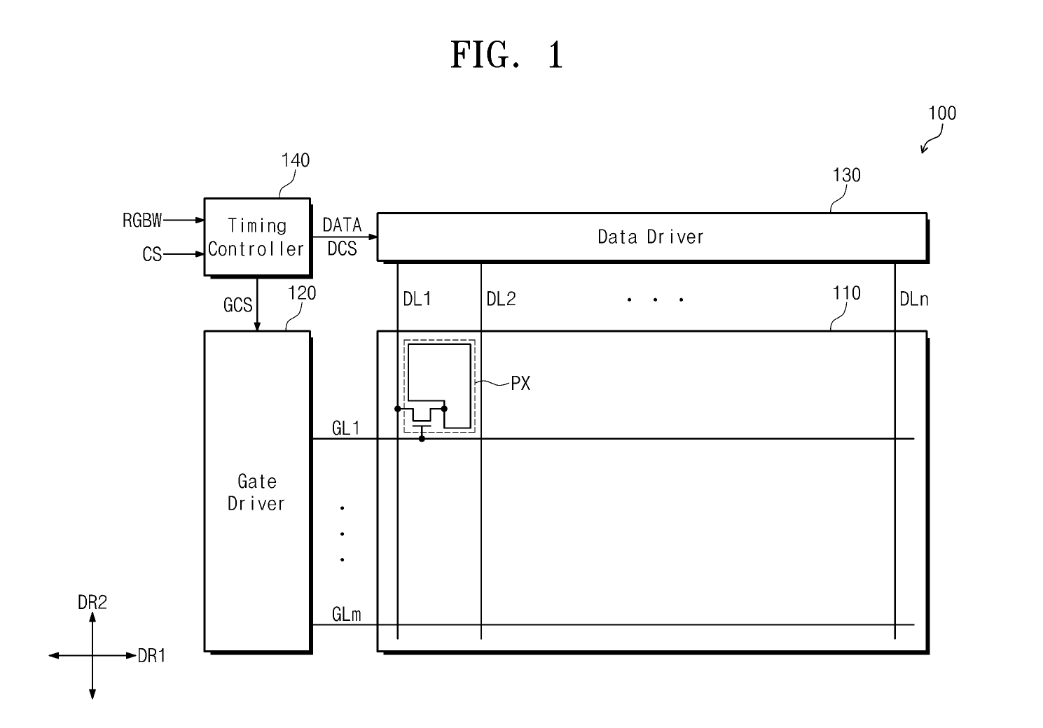

FIG. 1 is a schematic block diagram of a display apparatus according to an exemplary embodiment of the invention. Referring to FIG. 1, a display apparatus 100 according to an exemplary embodiment of the invention includes a display panel 110 displaying an image, a gate driver 120, a data driver 130, and a timing controller 140.

The display panel 110 includes a plurality of gate lines GL1 to GLm, a plurality of data lines DL1 to DLn, and a plurality of pixels PX. The pixels PX correspond to unit elements displaying an image. The resolution of the display panel 110 is determined according to the number of pixels PX. In the drawing, only one pixel PX is illustrated and the illustration of the remaining pixels are not provided. Each pixel PX may display any one of the primary colors. In an exemplary embodiment, the primary colors may include red, green, blue and white, for example. However, the primary colors are not limited thereto, and thus it will be well understood that various colors, such as yellow, cyan, and magenta, may be further included.

The gate driver 120 sequentially outputs gate signals respectively to the gate lines GL1 to GLm in response to a gate control signal GCS provided from the timing controller 140. The plurality of gate lines GL1 to GLn is respectively driven by the gate signals. In an exemplary embodiment, the gate driver 120 is implemented as an amorphous silicon gate using amorphous silicon (a-Si) thin film transistor (“TFT”), or as a circuit using oxide semiconductor, crystalline semiconductor, and polycrystalline semiconductor, and may be disposed on the same substrate together with the display panel 110. In another example, the gate driver 120 is implemented as a gate driving integrated circuit (“IC”) and may be connected to one side of the display panel 110.

The gate driver 120 of the invention uses a method of securing a charging rate by simultaneously operating the plurality of gate lines when a three dimensional (“3D”) image is displayed. Particularly, the gate driver 120 of the invention is controlled such that a gate pulse applied to one gate line has an overlapped interval with a gate pulse applied to one of the adjacent gate lines. That is, the gate driver 120 generates the gate line signals respectively applied to the gate lines such that an image interpolation effect is provided horizontally.

The data driver 130 drives the data lines DL1 to DLn in response to data DATA and data control signal DCS provided from the timing controller 140. The data driver 130 provides the data DATA interpolated vertically from the timing controller 140 to the display panel 110.

The timing controller 140 receives input image information RGBW and a plurality of control signal CS from the outside of the display apparatus 100. The timing controller 140 converts the data format of the input image information RGBW to meet the interface specification of the data driver 130, that is, converts the information into the data DATA, and provides the data DATA to the data driver 130. Also, based on the plurality of control signal CS, the timing controller 140 generates the data control signal DCS (for example, an output start signal, a horizontal start signal, etc.), and the gate control signal GCS (for example, a vertical start signal, a vertical clock signal, and vertical clock bar signal, etc.). The data control signal DCS is provided to the data driver 130 and the gate control signal GCS is provided to the gate driver 120.

The timing controller 140 of the invention may solve vertical moving lines and deterioration in resolution which occur in a display apparatus employing a driving method in which four or more gate lines are simultaneously driven to realize a 3D image. For such operations, the timing controller 140 may provide the gate control signal GCS or the data control signal DCS for an interpolation effect.

In an exemplary embodiment, the timing controller 140 may provide the gate control signal GCS to shift the turn-on times of the plurality of gate lines to which the same pixel data is allocated, for example. In an exemplary embodiment, when the same data signal DS is allocated to each unit of four gate lines, the timing controller 140 may shift the turn-on times of two gate lines of the four gate lines by a predetermined time with respect to the turn-on time of the remaining two gate lines. Hereinafter, such operation, which moves the turn-on times of the gate lines allocated with the same data, will be referred to as a gate shift. That is, through the gate shift operation adjusting the turn-on times of the plurality of gate lines allocated with the same data, a horizontal interpolation effect may be provided.

In addition, the timing controller 140 may combine and provide the data, which corresponds to the gate line which is not gate-shifted, to the pixels connected to the gate line to be gate-shifted among the four gate lines. That is, the data DATA modulated for data interpolation may be provided to the pixels of the gate line to be gate-shifted. Moreover, the timing controller 140 may gate-shift three gate lines of the four gate lines at equal time intervals. Furthermore, the timing controller 140 may modulate and provide the data such that the pixel data provided to the shifted gate line moves to the left or right in a gate line direction DR1. Such technical description will be given in more detail with reference to the following drawings.

An effect of the linear interpolation of an image may be achieved without a separate additional image interpolation filter through the function of the above-mentioned timing controller 140. In addition, the vertical moving lines observed in a high resolution display panel may be solved.

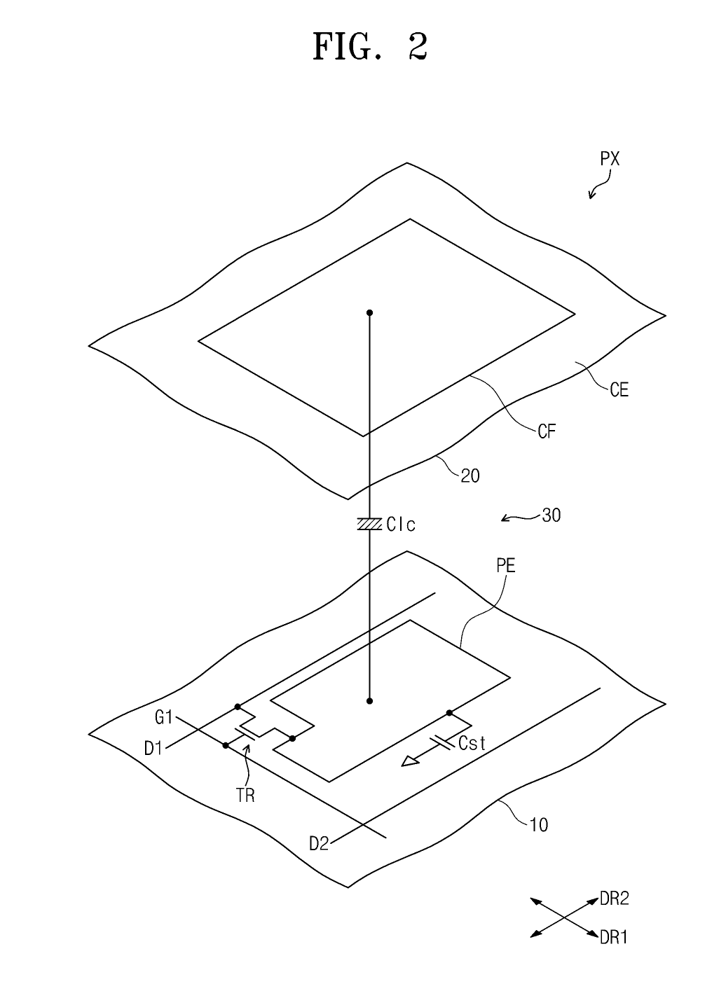

FIG. 2 is an equivalent circuit diagram of one pixel illustrated in FIG. 1. Referring to FIG. 2, the pixel PX may include a TFT TR connected to the gate lines GL1 to GLm, a liquid crystal capacitor Clc connected to the TFT TR, and a storage capacitor Cst connected to the liquid crystal capacitor Clc in parallel. In an exemplary embodiment, the storage capacitor Cst may not be provided when necessary. The TFT TR may be disposed on the lower substrate 10. A gate electrode of the TFT TR is connected to the first gate line GL1, a source electrode is connected to the first data line DL1, and a drain electrode may be connected to the liquid crystal capacitor Clc and the storage capacitor Cst.

The liquid crystal capacitor Clc has, as two terminals thereof, a pixel electrode PE disposed on the lower substrate 10 and a common electrode CE disposed on an upper substrate 20, and has a liquid crystal layer 30 therebetween serving as a dielectric. The pixel electrode PE is connected to the TFT TR, and the common electrode CE is entirely disposed on the upper substrate 20 and receives a common voltage. However, the invention is not limited thereto, and the common electrode CE may be disposed on the lower substrate 10, and in this case, a slit may be defined in least one of the two electrodes PE and CE.

The storage capacitor Cst plays an auxiliary role of the liquid crystal capacitor Clc, and may include the pixel electrode PE, a storage line (not shown), and an insulator disposed between the pixel electrode PE and the storage line (not shown). The storage line (not shown) may be disposed on the lower substrate 10 to overlap a portion of the pixel electrode PE. A constant voltage such as a storage voltage is applied to the storage line (not shown).

The pixel PX may express one of the primary colors. In an exemplary embodiment, the primary colors may include red, green, blue and white, for example. However, the primary colors are not limited thereto, but may further include various colors such as yellow, cyan, and magenta. The pixel PX may further include a color filter CF expressing one of the primary colors. In the illustrated example, it is exemplarily illustrated that a color filter CF is disposed at the upper substrate 20, but is not limited thereto. That is, in another exemplary embodiment, the color filter CF may be disposed on the lower substrate 10.

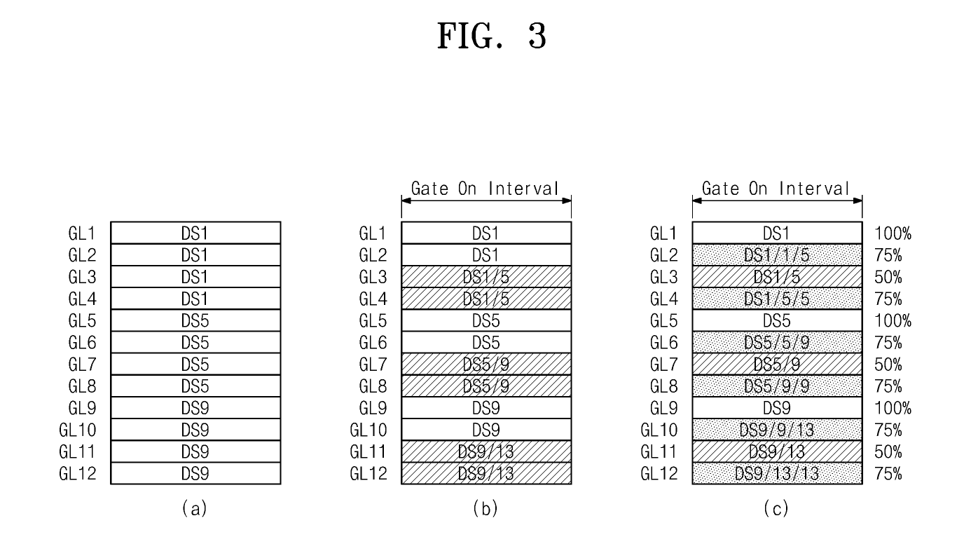

FIG. 3 is a view exemplarily illustrating a data interpolation method depending on a shift interval of a gate shift according to the invention. Referring to FIG. 3, an interpolation method of the invention will be described with regard to twelve gate lines GL1 to GL12. FIG. 3(a) illustrates a case in which four gate lines are simultaneously driven with the same data signals DS1, DS5 and DS9, and FIG. 3(b) illustrates a data interpolation method when data signals are gate-shifted by each unit of two gate lines. FIG. 3(c) is a view illustrating an interpolation method when three gate lines of the four gate lines are gate-shifted.

The data signals DS1, DS5, and DS9 are respectively provided during first to third data intervals. FIG. 3(a) illustrates a typical method in which the plurality of gate lines is simultaneously turned on to provide a high-speed panel charging rate. That is, the gate lines GL1 to GL4 are simultaneously turned on, where the data driver 130 may apply the same data signal DS 1 to each of the pixels PX connected to the gate lines GL1 to GL4. The first data interval, during which the data signal DS 1 is provided, overlaps the interval during which the gate lines GL1 to GL4 are turned on

Subsequently, the same data signal DS5 may be applied to each of the pixels connected to the gate lines GL5 to GL8 during different turn-on intervals. The same data signal DS9 may be applied to each of the pixels connected to the gate lines GL9 to GL12 during a successive turn-on interval. The second data interval, during which the data signal DS5 is provided, overlaps the interval during which the gate lines GL5 to GL8 are turned on, and the third data interval, during which the data signal DS9 is provided, overlaps the interval during which the gate lines GL9 to GL12 are turned on.

That is, the gate shift occurs by each unit of four gate lines, and the same data signal may be provided to the four gate lines. Here, for convenience of description, it is exemplarily assumed that the same data signal is allocated by each unit of four gate lines, but is not limited thereto. In another exemplary embodiment, the method of the invention may be applied to various gate driving methods in which two or more gate lines are simultaneously turned on as a unit.

FIG. 3(b) illustrates a data interpolation method according to an exemplary embodiment of the invention. Two gate lines GL3 and GL4 of the four gate lines GL1 to GL4 are simultaneously turned on at a shifted time. In addition, the data signal DS1/5 applied to the two gate lines GL3 and GL4 by the data driver 130 is determined with reference to the data signal DS1 applied to the gate lines GL1 and GL2 and the data signal DS5 applied to the gate lines GL5 and GL6. In an exemplary embodiment, the data signal DS1/5 applied to the two gate lines GL3 and GL4 by the data driver 130 may be provided as the combination of about 50 percent (%) of the data signal DS1 and about 50% of the data signal DS5, for example. Here, the 50% of each of the data signal DS1 and the data signal DS5 may mean a voltage level or a brightness value. In this case, the turn-on intervals of the gate lines GL3 and GL4 may overlap the first and second data intervals at a ratio of about 50:50.

The data interpolation method is also identically applied to the data signal DS5/9 applied to the gate lines GL7 and GL8. That is, the data signal DS5/9 applied to the two gate lines GL7 and GL8 by the data driver 130 is determined with reference to the data signal DS5 applied to the gate lines GL5 and GL6 and the data signal DS9 applied to the gate lines GL9 and GL10. In an exemplary embodiment, the data signal DS5/9 applied to the two gate lines GL7 and GL8 may be provided as the combination of about 50% of the data signal DS5 and about 50% of the data signal DS9, for example. In this case, the turn-on intervals of the gate lines GL7 and GL8 may overlap the second and third data intervals at a ratio of about 50:50.

FIG. 3(c) illustrates another exemplary embodiment of the data interpolation method. In addition to the data interpolation of FIG. 3(b), it is illustrated that an additional data interpolation may be performed on the even-numbered gate lines GL2, GL4, GL6, GL8, GL10, and GL12. That is, the data signal DS1/1/5 applied to the gate line GL2 may be provided as the combination of about 75% of the data signal DS1 and about 25% of the data signal DS5, for example. Also, the data signal DS1/5/5 applied to the gate line GL4 may be provided as the combination of about 25% of the data signal DS1 allocated to the gate line GL1 and about 75% of the data signal DS5 allocated to the gate line GLS, for example. In this case, the turn-on interval of the gate lines GL2 may overlap the first and second data intervals at a ratio of about 25:75.

Heretofore, description was given of the interpolation method of the data signal provided to each pixel according to the number of gate lines which are simultaneously gate-shifted. The gate shift method and the data interpolation method on each of the gate lines will be described in more detail with reference to the drawings described below.

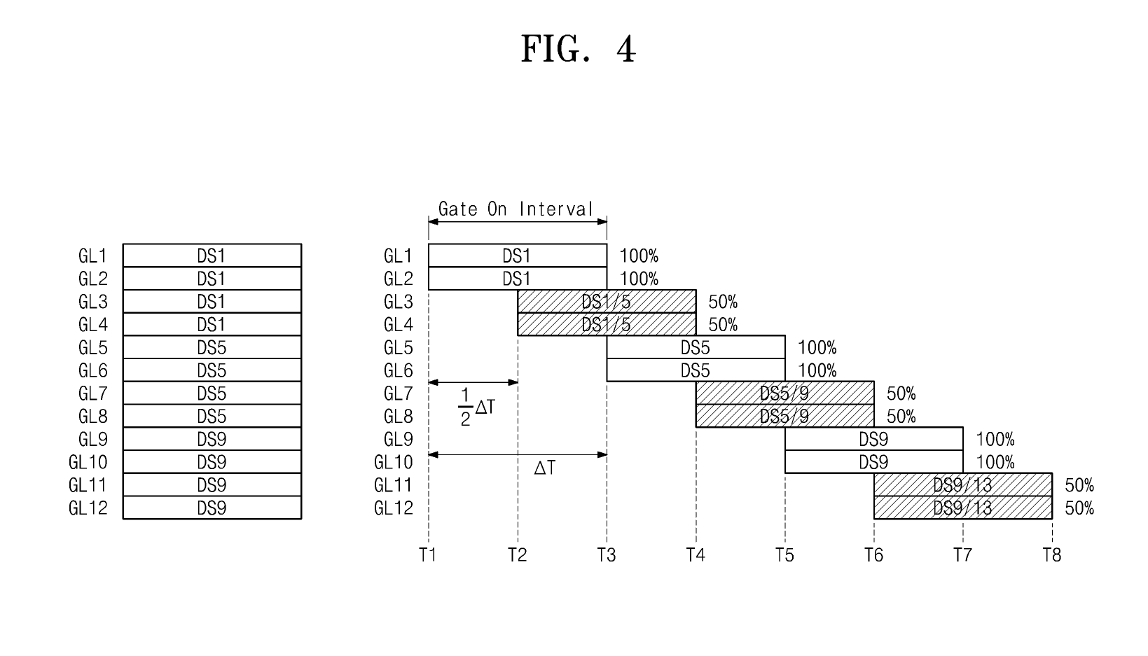

FIG. 4 is a view illustrating the gate shift method described in FIG. 3. Referring to FIG. 4, the gate signal provided by the gate driver 120 is gate-shifted such that two gate lines are simultaneously turned on. This will be described in more detail as follows.

First, the gate lines GL1 and GL2 are turned on from the time T1 to the time T3. Next, the gate lines GL3 and GL4 allocated with the same data as the gate lines GL1 and GL2 may be turned on from the time T2 to the time T4. The gate lines GL5 and GL6 are turned on from the time T3 to the time T5. Next, the gate lines GL7 and GL8 allocated with the same data as the gate lines GL5 and GL6 may be turned on from the time T4 to the time T6. The gate lines GL9 and GL10 are turned on from the time T5 to the time T7. Next, the gate lines GL11 and GL12 allocated with the same data as the gate lines GL9 and GL10 may be turned on from the time T6.

In an exemplary embodiment of the invention, the first data interval corresponds to the interval from the time T1 to the time T3, the second data interval corresponds to the interval from the time T3 to the time T5, and the third data interval starts from the time T5.

At the time T1, the gate lines GL1 and GL2 are turned on. The interval, during which the gate lines GL1 and GL2 are turned on, may be defined as the width of a gate pulse. In an exemplary embodiment, at the time T1, the gate lines GL1 and GL2 may be turned on during the ΔT interval, for example. Here, the data signal, which is provided to the pixels PX of the gate lines GL1 and GL2 by the data driver 130, may be provided as the data signal DS1 allocated to the gate lines GL1 to GL4.

At the time T2, the gate-shifted gate lines GL3 and GL4 are turned on. The gate lines GL3 and GL4 may be turned on and off at the times which are respectively delayed about ΔT/2 with respect to the times when the gate lines GL1 and GL2 are turned on and off. At this point, as described above, the turn-on interval of the gate lines GL3 and GL4 may overlap the first and second data intervals at a ratio of about 50:50. Accordingly, the data signal provided to the pixels PX of the gate lines GL3 and GL4 by the data driver 130 may be provided as the data signal DS1/5 obtained by combining about 50% of the data signal DS1 allocated to the gate lines GL1 and GL2 and about 50% of the data signal DS5 allocated to the gate line GL5. As a result, the grayscale of the image displayed at the pixels connected to the gate lines GL3 and GL4 may have a median value between the grayscale of the image displayed at the pixels connected to the gate lines GL1 and GL2 and the grayscale of the image displayed at the pixels connected to the gate lines GL5 and GL6.

Through such a method, the gate lines GL3 and GL4, GL7 and GL8, and GL11 and GL12 are gate-shifted by a predetermined interval, and are applied with a data interpolation in which the firstly allocated data values are modulated with reference to the data values of the adjacent gate lines. Accordingly, the phenomenon such as vertical moving lines may be solved or reduced by the gate shifts of the gate lines.

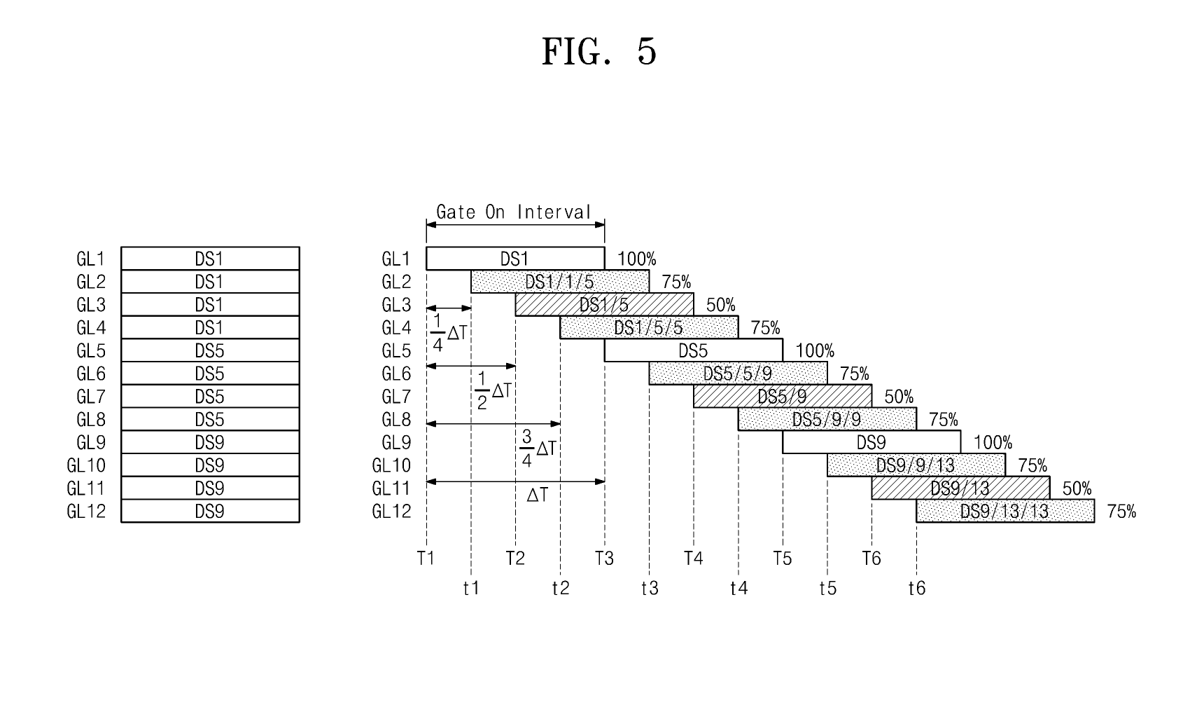

FIG. 5 is a view illustrating a gate shift method according to another exemplary embodiment of the invention. Referring to FIG. 5, the gate lines may be gate-shifted so as to be turned on at the respective times different from each other by the gate signal provided by the gate driver 120. In addition, the data interpolation on each of the gate lines may be also performed so as to have weights according to the inter-line distances between the gate line and the adjacent reference gate lines. This will be described in more detail as follows.

The gate lines GL1, GL5, and GL9 may be respectively turned on for a predetermined pulse interval ΔT at the times T1, T3, and T5. Each of the gate lines GL1, GL5, and GL9 is a unit which is controlled to allow turn-on times thereof not to overlap each other. That is, the gate line GL1 may be turned on at the time T1 and turned off at the time T3. The gate line GL5 may be turned on at the time T3 and turned off at the time T5. The gate line GL9 may be turned on at the time T5 and turned off at the time T7 (not shown). The gate lines GL1, GL5, and GL9 may be driven in such a way that turn-on intervals thereof do not overlap each other.

However, differently from the exemplary embodiment shown in FIG. 4, the gate lines GL2, GL3, and GL4 are shifted by a predetermined interval with respect to the turn-on time of the gate line GL1. The turn-on times of the gate lines GL2, GL3, and GL4 may be gate-shifted so as to overlap a portion of the turn-on interval of the gate line GL1. That is, the gate line GL2 may be turned on at the time tl which is shifted ΔT/4 from the turn-on time of the gate line GL1. The gate line GL3 may be turned on at the time T2 which is shifted ΔT/2 from the turn-on time of the gate line GL1. The gate line GL4 may be turned on at the time t2 which is shifted (3ΔT)/4 from the turn-on time of the gate line GL1. Here, the shift time (ΔT)/4 of each of the gate lines is based on an interval during which one gate line is turned on. That is, although it is described that the gate lines GL2, GL3, and GL4 are gate-shifted by a pulse width during which one gate line is turned on, it will be well understood that the shift intervals of the shifts ΔT/4, ΔT/2, and (3ΔT)/4 may be variously adjusted. That is, the shift interval may vary with a relative position on the display panel 110 (see FIG. 1).

In addition, the data interpolation on each of the gate lines GL2, GL3, and GL4 may be performed according to relative inter-line distances between the gate line GL1 and the gate line GL5. That is, since the gate line GL3 is located at the middle of the gate line GL1 and the gate line GL5, the pixel data of each of the gate lines GL1 and GL5 may be combined with the same weight. In an exemplary embodiment, the data signal DS1/5 applied to the gate line GL3 may be generated by combining about 50% of the data signal DS1 of the gate line GL1 and about 50% of the data signal DS5 of the gate line GL5, for example.

The gate line GL2 is located at about ¼ position between the gate line GL1 and the gate line GL5. Accordingly, the data signal DS1/1/5 to be applied to the pixels of the gate line GL2 may be applied by combining the data applied to the pixels of each of the gate lines GL1 and GL5, with weights according to relative distances. In an exemplary embodiment, the data signal DS1/1/5 applied to the gate line GL2 may be generated by combining about 75% of the data signal DS1 of the gate line GL1 and about 25% of the data signal DS5 of the gate line GL5, for example.

The gate line GL4 is located at about ¾ position between the gate line GL1 and the gate line GL5. Accordingly, the data signal DS1/5/5 applied to the pixels of the gate line GL4 may be applied by combining the data applied to the pixels of the gate lines GL1 and GL5, with weights according to relative distances. In an exemplary embodiment, the data signal DS1/5/5 applied to the gate line GL4 may be generated by combining about 25% of the data signal DS1 of the gate line GL1 and about 75% of the data signal DS5 of the gate line GL5, for example.

The gate shifts and the data interpolations of the gate lines GL6, GL7, and GL8 located between the gate lines GL5 and GL9 may be performed in the same way as those of the gate lines GL2, GL3, and GL4 described above. That is, the gate lines GL6, GL7, and GL8 are gate-shifted for predetermined intervals with respect to the turn-on time of the gate line GL5. However, gate shift may be performed such that the turn-on times of the gate lines GL6, GL7, and GL8 overlap a portion of the turn-on interval of the gate line GL5. That is, the gate line GL6 may be turned on at the time t3 which is shifted ΔT/4 from the turn-on time of the gate line GL5. The gate line GL7 may be turned on at the time T3 which is shifted ΔT/2 from the turn-on time of the gate line GL5. The gate line GL8 may be turned on at the time t4 which is shifted (3ΔT)/4 from the turn-on time of the gate line GL5. However, the shift intervals of the gate shift are only exemplary, and should be well understood to diversely vary.

The data interpolation on each of the gate lines GL6, GL7, and GL8 may be performed according to the relative distances between the gate line GL5 and the gate line GL9. That is, since the gate line GL7 is located at the middle of the gate line GL5 and the gate line GL9, the pixel data of each of the gate lines GL5 and GL9 may be combined with the same weight. In an exemplary embodiment, the data signal DS5/9 applied to the gate line GL7 may be provided as the combination of about 50% of the data signal DS5 of the gate line GL5 and about 50% of the data signal DS9 of the gate line GL9. The gate line GL6 is located at about ¼ position between the gate line GL5 and the gate line GL9. Accordingly, the data signal DS5/5/9 applied to the pixels of the gate line GL6 may be applied by combining the data applied to the pixels of the gate lines GL5 and GL9, with weights according to the relative distances. In an exemplary embodiment, the data signals DS5/5/9 applied to the gate line GL6 may be generated by combining about 75% of the data signal DS5 of the gate line GL5 and about 25% of the data signal DS9 of the gate line GL9, for example. In the same manner, the gate line GL8 is located at about ¾ position between the gate line GL5 and the gate line GL9. Accordingly, the data signal DS5/9/9 applied to the pixels of the gate line GL8 may be applied by combining the data applied to the pixels of the gate lines GL5 and GL9, with weights according to the relative distances. In an exemplary embodiment, the data signal DS5/9/9 applied to the gate line GL8 may be provided as the combination of about 25% of the data signal DS5 of the gate line GL5 and about 75% of the data signal DS9 of the gate line GL9, for example.

The gate shifts and the data interpolations of the gate lines GL10, GL11, and GL12 located between the gate lines GL9 and GL13 may be performed in the same way as described above, and description related to this will not be provided herein.

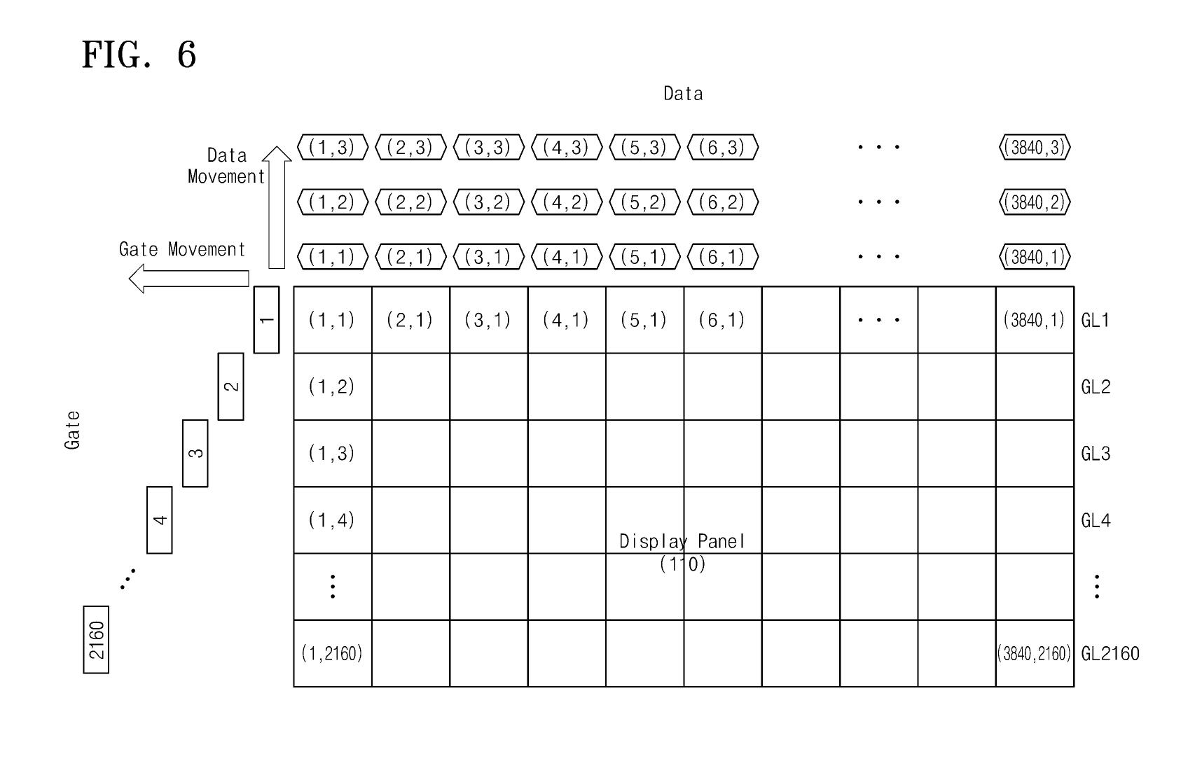

FIG. 6 is a view illustrating an example of an image interpolation method according to the invention. Referring to FIG. 6, when a two dimensional (“2D”) image is realized, the image may be displayed without performing a gate shift or a data interpolation.

The timing controller 140 (refer to FIG. 1) may not perform a data interleaving or a gate shift through the gate driver 120 (refer to FIG. 1) and the data driver 130 (refer to FIG. 1). When an image is displayed, each of the gate lines is sequentially turned on at different times, and the data signal corresponding to each of the pixels may be provided to the pixels connected to each of the gate lines.

In an exemplary embodiment, the gate lines are sequentially turned on according to a turn-on sequence of GL1-GL2-GL3-GL4- . . . -GL2160, i.e., from the gate line GL1 to the gate line GL2160, for example. Here, the turn-on intervals of the gate lines may not overlap each other. Also, the data applied to the pixels connected to each of the gate lines may be differently allocated to each row. That is, when the gate line GL1 is turned on, the data {(1,1), (2,1), (3,1), (4,1), . . . , (3840,1)} may be applied to the pixels connected to the gate line GL1. When the gate line GL2 is turned on, the data {(1,2), (2,2), (3,2), (4,2), . . . , (3840,2)} may be applied to the pixels connected to the gate line GL2. When the gate line GL3 is turned on, the data {(1,3), (2,3), (3,3), (4,3), . . . , (3840,3)} may be applied to the pixels connected to the gate line GL3. In this way, the data may be applied to all pixels included in the display panel 110 sequentially.

In short, when a 2D image is realized, the timing controller 140 may operate such that the gate shift or the data interpolation is not performed.

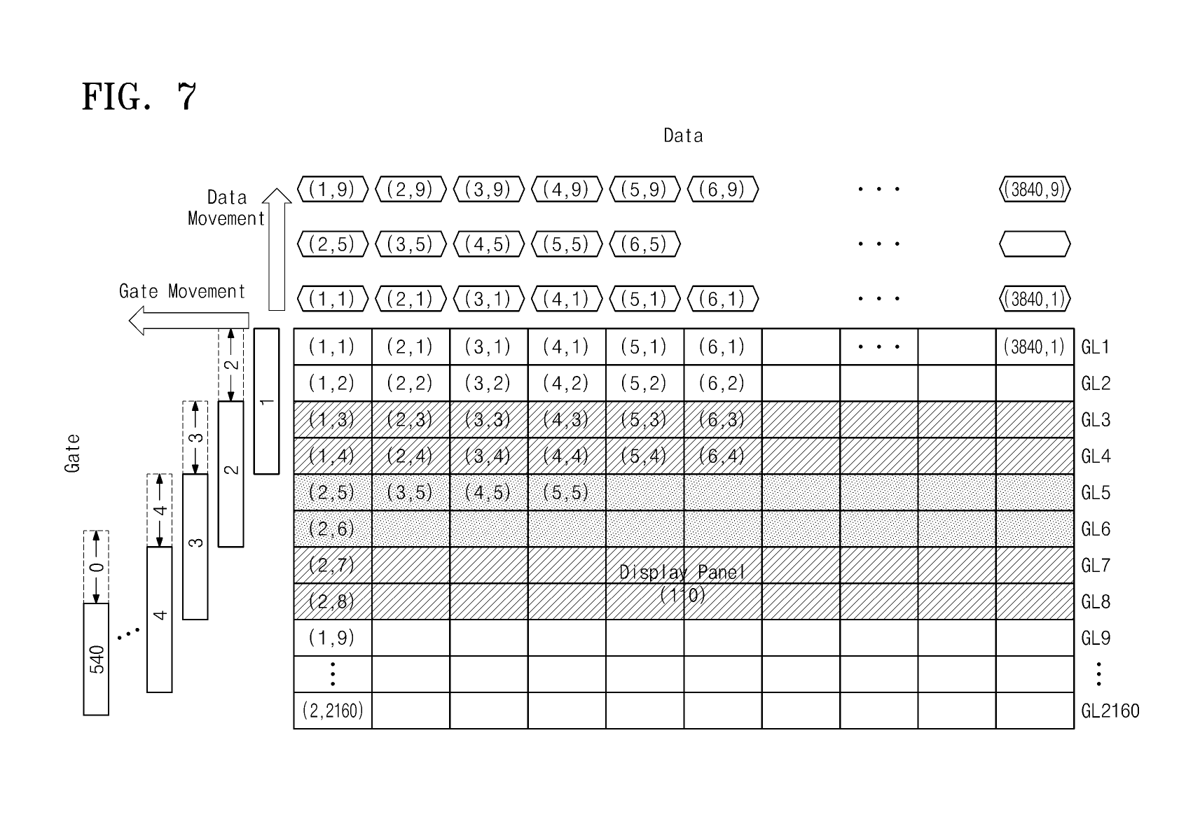

FIG. 7 is a view schematically illustrating a gate shift method and a data interpolation method according to another exemplary embodiment of the invention. Referring to FIG. 7, when a 3D image is realized, four gate lines are simultaneously selected, and a gate shift occurs with respect to two gate lines of the four gate lines. Also, the same image data is applied to each unit of the four gate lines. Particularly, the data allocated to each unit of four gate lines may be moved to the left or right by the number of one or more pixels. Here, the data interpolation by the data driver 130 may be performed with the same number of the pixels connected to the two gate-shifted gate lines.

First, the gate lines GL1 and GL2 are selected and turned on. Next, when the selected gate lines GL1 and GL2 are turned on, the data {(1,1), (2,1), (3,1), (4,0), . . . , (3840,1)} and {(1,2), (2,2), (3,2), (4,2), . . . , (3840,2)} may be simultaneously and respectively applied to the pixels connected to the gate lines GL1 and GL2. When the gate-shifted gate lines GL3 and GL4 are turned on, the data {(1,1), (2,1), (3,1), (4,1), . . . , (3840,1)} may be applied to the pixels connected to the gate lines GL3 and GL4.

Next, the gate lines GL5 and GL6 are selected and turned on. Also, when the selected gate lines GL5 and GL6 are turned on, the data {(2,5), (3,5), (4,5), (5,5), . . . , (3840,5)} and {(2,6), (3,6), (4,6), (5,6), . . . , (3840,6)} may be respectively applied to the pixels connected to the gate lines GL5 and GL6. That is, the data {(1,5), (2,5), (3,5), (4,5), . . . , (3840,5)} allocated to the gate lines GL5 and GL8 may be provided by moving the data to the left by one pixel. That is, the data {(2,5), (3,5), (4,5), (5,5), . . . , (3840,5)} and {(2,6), (3,6), (4,6), (5,6), . . . , (3840,6)} moved by one pixel may be respectively provided to the gate lines GL5 and GL6. Also, when the shifted gate lines GL7 and GL8 of the gate lines GL7 to GL8 are turned on, the data {(2,7), (3,7), (4,7), (5,7), . . . , (3840,7)} and {(2,8), (3,8), (4,8), (5,8), . . . , (3840,8)} may be applied simultaneously.

The above-mentioned movement of data to the left or right is not applied to the gate lines GL9 to GL12, but the data, which are moved one pixel to the left or right, may be provided to the gate lines GL13 to GL16. Such movement of the data may be performed independently of the interpolation of the data. That is, when the corresponding gate line is turned on after the data interpolation is completed, the movement of the data interpolated to the left or right may be performed.

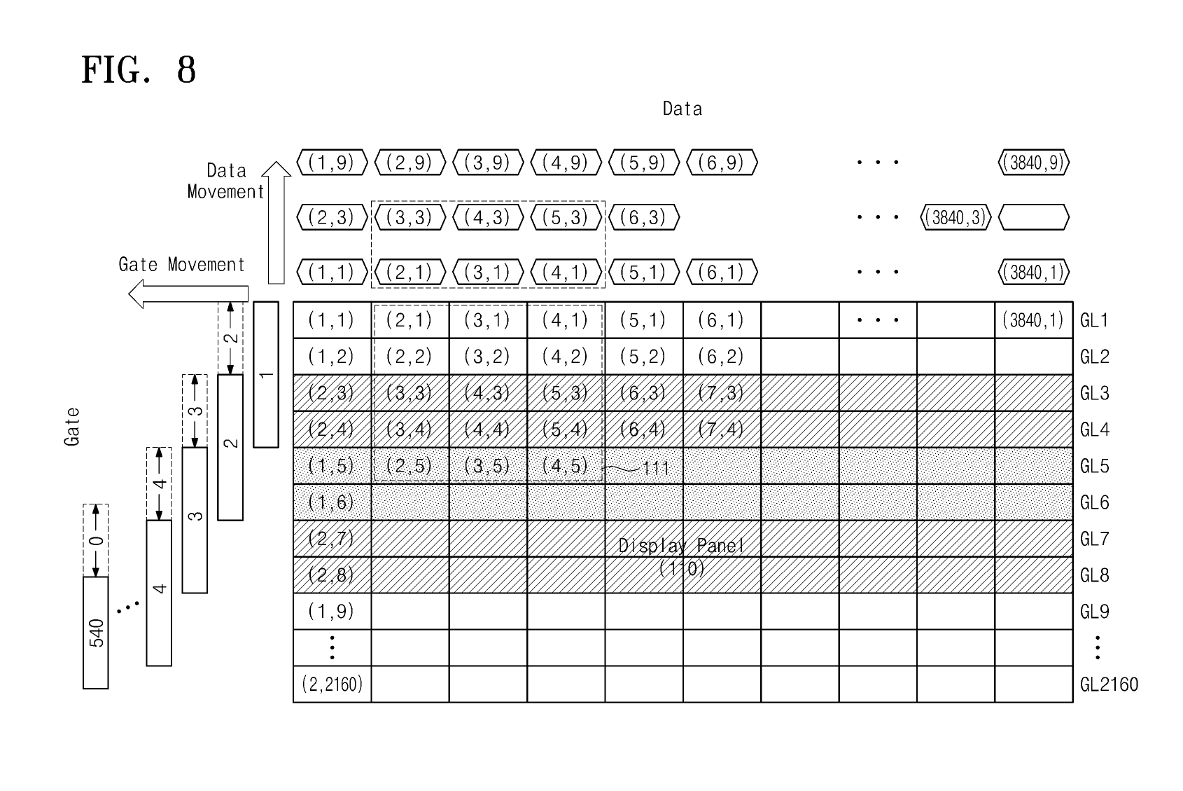

FIG. 8 is a view schematically illustrating a gate shift method and a data interpolation method according to another exemplary embodiment of the invention. Referring to FIG. 8, when a 3D image is realized, four gate lines are simultaneously selected, and two gate lines of the four gate lines are gate-shifted. Here, the data connected to the gate lines, in which a shift occurs, may be moved to the left by one or more pixels. The data interpolation by the data driver 130 (refer to FIG. 1) may be performed with the same number of the pixels connected to the two gate-shifted gate lines.

First, the gate lines GL1 and GL2 are selected and turned on. Also, when the selected gate lines GL1 and GL2 are turned on, the data {(1,1), (2,1), (3,1), (4,0), . . . , (3840,1)} and {(1,2), (2,2), (3,2), (4,2), . . . , (3840,2)} may be applied simultaneously and respectively to the pixels connected to the gate lines GL1 and GL2. When the gate-shifted gate lines GL3 and GL4 are turned on, the data {(2,3), (3,3), (4,3), (5,3), . . . , (3840,3)} and {(2,4), (3,4), (4,4), (5,4), . . . , (3840,4)}, which are shifted one pixel to the left, may be respectively applied to the pixels connected to the gate lines GL3 and GL4.

Next, the gate lines GL5 and GL6 are selected and turned on. Also, when the selected gate lines GL5 and GL6 are turned on, the data {(1,5), (2,5), (3,5), (4,5), . . . , (3840,5)} and {(1,6), (2,6), (3,6), (4,6), . . . , (3840,6)} may be applied simultaneously and respectively to the pixels connected to the gate lines GL5 and GL6. That is, the data {(1,5), (2,5), (3,5), (4,5), . . . , (3840,5)} and {(1,6), (2,6), (3,6), (4,6), . . . , (3840,6)} allocated to the gate lines GL5 and GL6 may be provided to the gate lines GL5 and GL6 without movement. In addition, the data {(2,7), (3,7), (4,7), (5,7), . . . , (3840,7)} and {(2,8), (3,8), (4,8), (5,8), . . . , (3840,8)} moved by one pixel may be respectively provided to the shifted gate lines GL7 and GL8.

In the same manner, the above-mentioned data movement is not applied to the gate lines GL9 and GL10, but the data, which are shifted one pixel to the left, may be provided to only the pixels connected to the shifted gate lines GL11 and GL12. Such movement of the data may be performed independently of the interpolation of the data. That is, when the corresponding gate line is turned on, after the data interpolation is completed, the movement of the data interpolated to the left may be performed.

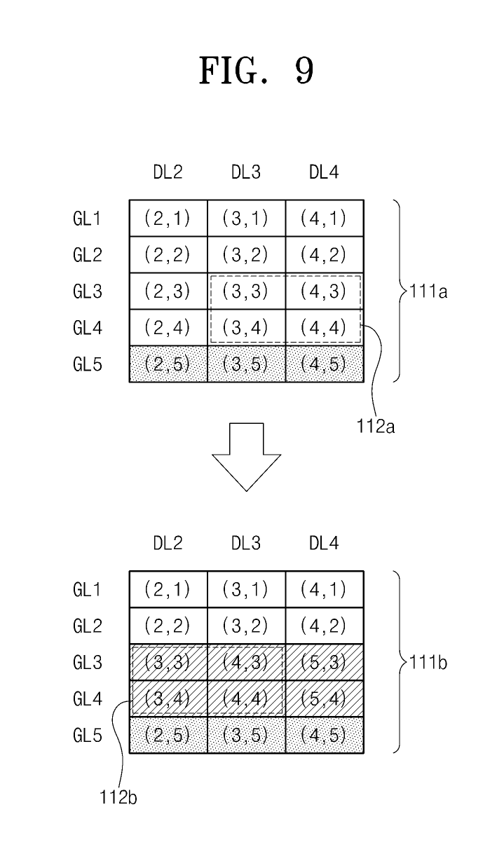

FIG. 9 is a view illustrating a data driving method for some pixels of FIG. 8. Referring to FIG. 9, the data allocated to the pixels 111 connected to the gate lines GL1 to GL5 and the data lines DL2 to DL4 are illustrated.

In the pixels 111a, the pixel data after data interpolation is completed and before movement to the left occur are respectively illustrated. In an exemplary embodiment, the data allocated to the gate line GL1 may be provided without a change to all the pixels connected to the gate lines GL1 and GL2. Also, the combined data of the data allocated to the gate line GL1 and the data allocated to the gate line GL5 (50%) may be allocated to all the pixels connected to the gate lines GL3 and GL4. The data allocated to the gate line GL5 may be provided without a change to all the pixels connected to the gate line GL5, for example.

In the pixels 111b, the pixel data of the pixels of the gate lines GL3 and GL4 which are to be gate-shifted after the data movement to the left are respectively illustrated. In an exemplary embodiment, the data allocated to the gate line GL1 may be provided without a change to all the pixels connected to the gate lines GL1 and GL2 (100%), for example. Also, the combined data of the data allocated to the gate line GL1 and the data allocated to the gate line GL5 may be allocated to all the pixels connected to the gate-shifted gate lines GL3 and GL4. However, the data moved one pixel to the left is provided to the pixels connected to the gate-shifted gate lines GL3 and GL4. Such movement of the pixel data to the left may be described as four pixel data 112a moving to the pixel data 112b.

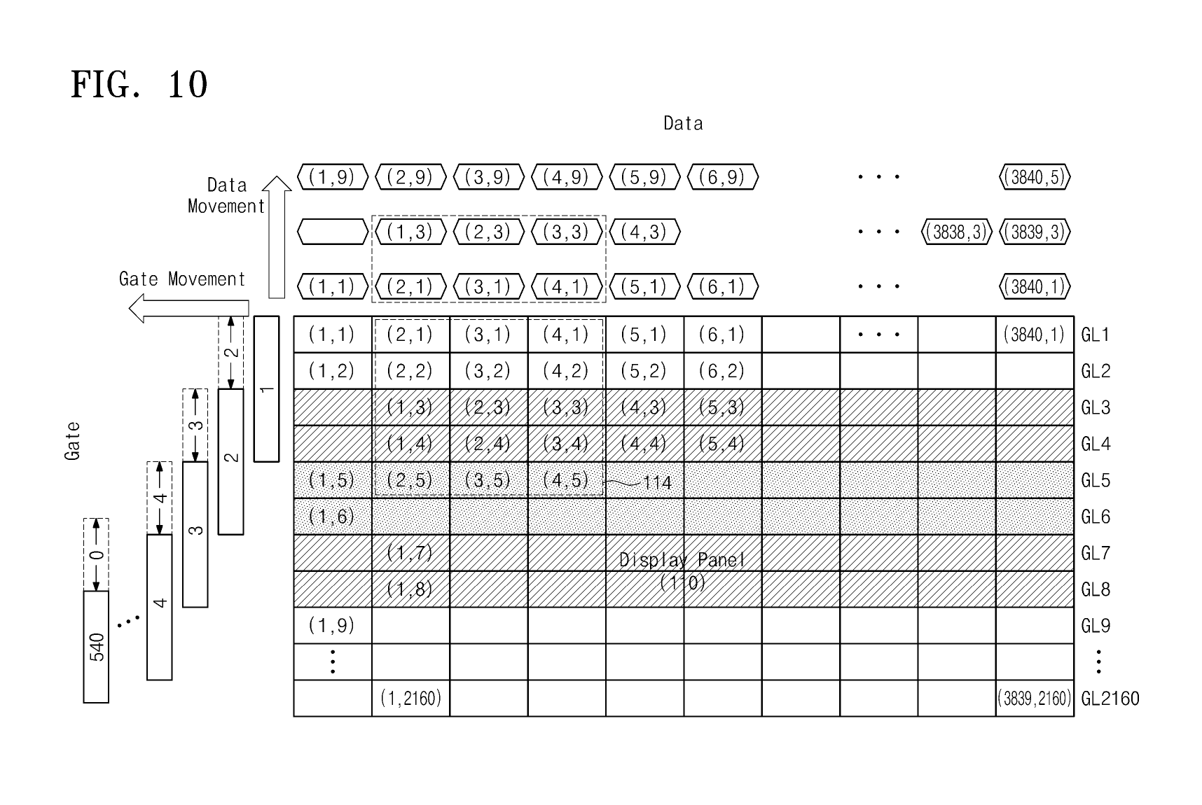

FIG. 10 is a view schematically illustrating a gate shift method and a data interpolation method according to another exemplary embodiment of the invention. Referring to FIG. 10, when a 3D image is realized, four gate lines are simultaneously selected, and two gate lines of the four gate lines are gate-shifted. Here, the data connected to the shifted gate lines may be moved one or more pixels to the right. The data interpolation by the data driver 130 may be performed with the same number of the pixels connected to the two gate-shifted gate lines.

First, the gate lines GL1 and GL2 are selected and simultaneously turned on. Also, when the selected gate lines GL1 and GL2 are turned on, the data {(1,1), (2,1), (3,1), (4,1), . . . , (3840,1)} and {(1,2), (2,2), (3,2), (4,2), . . . , (3840,2)} may be applied simultaneously to the pixels connected to the gate lines GL1 and GL2.

Next, when the gate-shifted gate lines GL3 and GL4 are turned on, the data {(X,X), (1,3), (2,3), (3,3), (4,3), (5,3), . . . , (3839,3)} and {(X,X), (1,4), (2,4), (3,4), (4,4), (5,4), . . . , (3839,4)}, which are shifted one pixel to the right, may be respectively applied to the pixels connected to the gate lines GL3 and GL4. Here, the data (X,X) may be treated as a dummy data, and indicated as a space in the drawings.

Also, the gate lines GL5 and GL6 are selected and turned on. When the selected gate lines GL5 and GL6 are turned on, the data {(1,5), (2,5), (3,5), (4,5), (5,5), . . . , (3840,5)} and {(1,6), (2,6), (3,6), (4,5), (5,5), . . . , (3840,5)} may be applied simultaneously and respectively to the pixels connected to the gate lines GL5 and GL6. That is, the data {(1,5), (2,5), (3,5), (4,5), . . . , (3840,5)} and {(1,6), (2,6), (3,6), (4,5), (5,5), . . . , (3840,5)} allocated to the gate lines GL5 and GL6 may be provided, without a movement, to the gate lines GL5 and GL6 which are not gate-shifted. In addition, the data {(X,X), (1,7), (2,7), (3,7), (4,7), (5,7), . . . , (3839,7)} and {(X,X), (1,8), (2,8), (3,8), (4,8), (5,8), . . . , (3839,8)} moved by one pixel may be provided to the gate-shifted gate lines GL7 and GL8.

The limitation of vertical moving lines may be easily solved through the above-mentioned data movement of a unit of two gate lines.

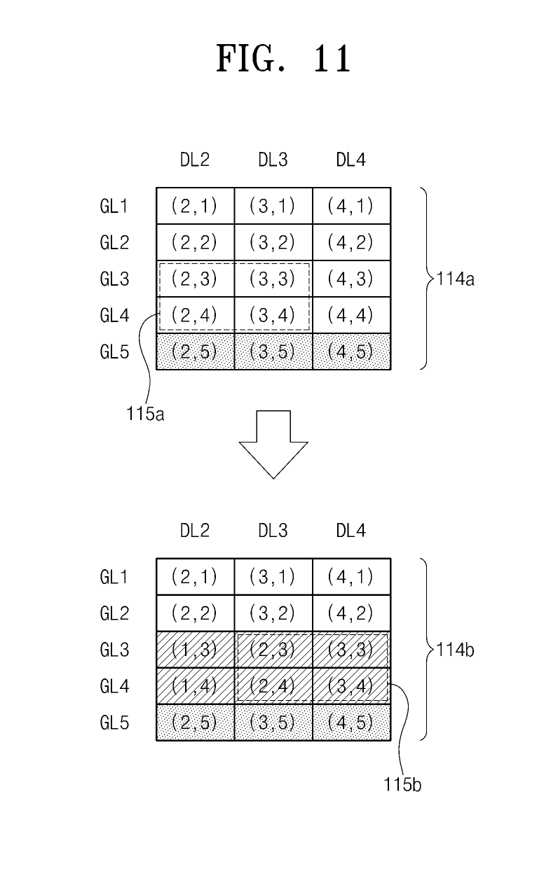

FIG. 11 is a view illustrating a data driving method for some pixels of FIG. 10. Referring to FIG. 11, the data, allocated to the pixels 114 (see FIG. 11) connected to the gate lines GL1 to GL5 and the data lines DL2 to DL4, are illustrated.

In the pixels 114a, the pixel data after the data interpolation, in which the data of adjacent gate lines are used, is completed, and before the movement to the right occurs are respectively illustrated. In an exemplary embodiment, the data allocated to the gate line GL1 may be provided without a change to all the pixels connected to the gate lines GL1 and GL2 (100%), for example. To all the pixels connected to the gate lines GL3 and GL4, the combined data of the data allocated to the gate line GL1 and the data allocated to the gate line GL5 may be allocated (50%), for example. To all the pixels connected to the gate line GL5, the data allocated to the gate line GL5 may be provided again without a change (100%), for example.

In the pixels 114b, the pixel data of the pixels of the gate lines GL3 and GL4 to be gate-shifted after the data movement to the right occurs are respectively illustrated. In an exemplary embodiment, the data allocated to the gate line GL1 may be provided without a change to all the pixels connected to the gate lines GL1 and GL2 (100%), for example. To all the pixels connected to the gate-shifted gate lines GL3 and GL4, the data combining the data allocated to the gate line GL1 and the data allocated to the gate line GL5 may be allocated. However, the data of the pixels connected to the gate-shifted gate lines GL3 and GL4 are moved one pixel to the left. Such movement to the right of the pixel data may be described as four pixel data 115a moving to the pixel data 115b.

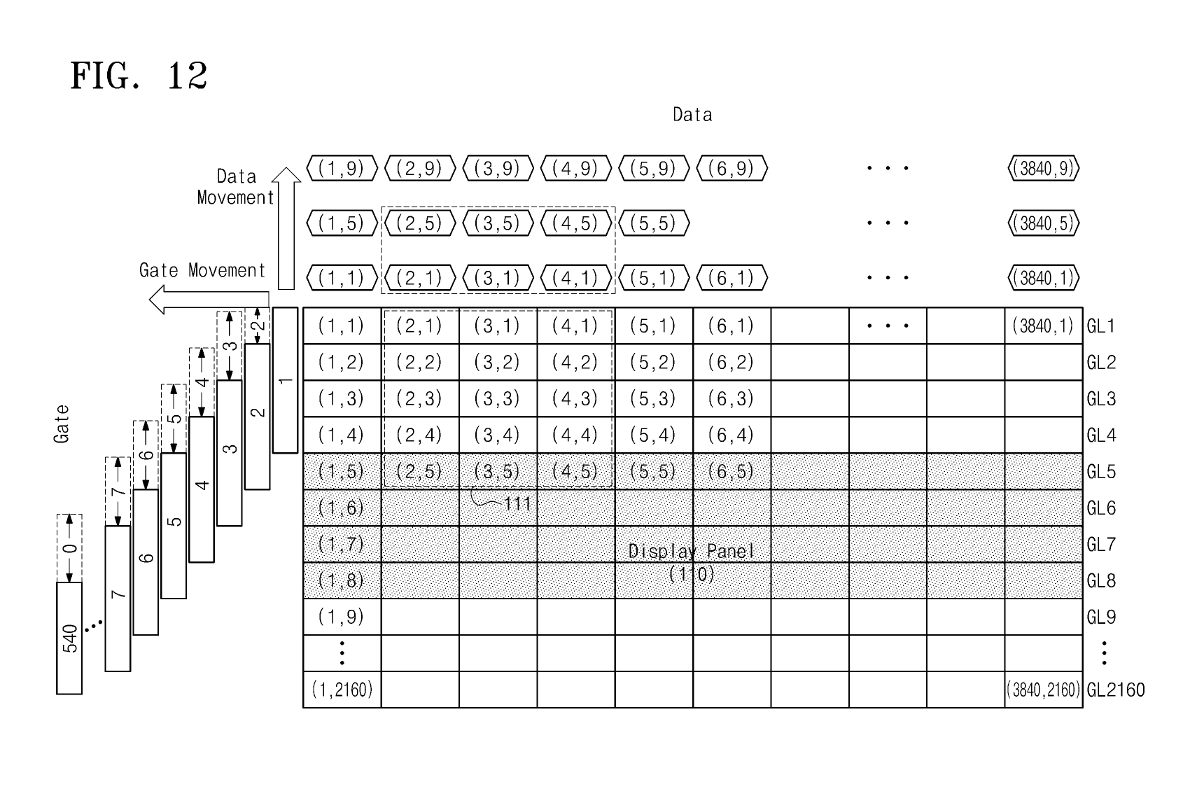

FIG. 12 is a view schematically illustrating a gate shift and a data interpolation method according to another exemplary embodiment of the invention. Referring to FIG. 12, when a 3D image is realized, the gate lines allocated with the same data are respectively turned on sequentially at different times. That is, three gate lines of the selected four gate lines are respectively gate-shifted in different shift intervals from each other. Here, the data movement of the pixels connected to the shifted gate lines does not occur.

First, the gate line GL1 is selected. Also, when the selected gate line GL1 is turned on, the data {(1,1), (2,1), (3,1), (4,0), . . . , (3840,1)} allocated to the gate line GL1 may be applied to the pixels connected to the gate line GL1. Next, when the shifted gate line GL2 is turned on, the data {(1,2), (2,2), (3,2), (4,2), . . . , (3840,2)}, which are linearly interpolated by about 75% with reference to each data of the gate lines GL1 and GLS, may be applied to the pixels connected to the gate line GL2, for example. Also, when the gate-shifted gate line GL3 is turned on, the data {(1,3), (2,3), (3,3), (4,3), . . . , (3840,3)}, which are linearly interpolated by about 50%, may be applied to the pixels connected to the gate line GL3. When the gate line GL4 is turned on, the 75% data {(1,4), (2,4), (3,4), (4,4), . . . , (3840,4)} may also be applied to the pixels connected to the gate line GL4, for example. As a result, only the gate shift and the linear interpolation may be applied to the gate lines GL1 to GL4 allocated with the same data without a data movement to the left or right.

Also, when the gate line GL5 is turned on, the data {(1,5), (2,5), (3,5), (4,5), . . . , (3840,5)} allocated to the gate line GL5 may be applied to the pixels connected to the gate line GL5. Next, when the gate-shifted gate line GL6 is turned on, the data {(1,5), (2,5), (3,5), (4,5), . . . , (3840,5)}, which are linearly interpolated by about 75% with reference to each data of the gate lines GL5 and GL9, may be applied to the pixels connected to the gate line GL6, for example. Also, when the gate-shifted gate lines GL7 is turned on, the data {(1,7), (2,7), (3,7), 4,7), . . . , (3840,7)}, which are linearly interpolated by about 50%, may be applied to the pixels connected to the gate line GL7, for example. When the gate line GL8 is turned on, the 75% data {(1,8), (2,8), (3,8), (4,8), . . . , (3840,8)} may be also applied to the pixels connected to the gate line GL8, for example. As a result, only the gate shift and the linear interpolation may be applied to the gate lines GL5 to GL8 allocated with the same data without a data movement to the left or right.

The gate-shift and the linear interpolation method applied to the gate lines GL5 to GL8 may also be sequentially applied to the remaining gate lines GL9 to GL2160.

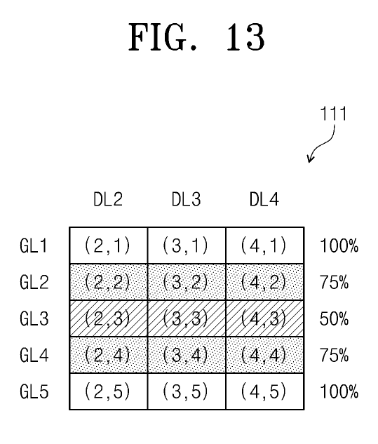

FIG. 13 is a view illustrating a data driving method for some pixels of FIG. 12. Referring to FIG. 13, the data, allocated to the pixels 111 (see FIG. 12) connected to the gate lines GL1 to GL5 and the data lines DL2 to DL4, are illustrated.

The data interpolation using the driving data of the gate lines adjacent to the pixels 111 is performed on the pixels 111. In an exemplary embodiment, the data allocated to the gate line GL1 may be provided without a change to all the pixels connected to the gate lines GL1 (100%), for example. To all the pixels connected to the gate lines GL2, the combined data of about 75% of the data allocated to the gate line GL1 and about 25% of the data allocated to the gate line GL5 may be allocated, for example. To all the pixels connected to the gate lines GL3, the combined data of about 50% of the data allocated to the gate line GL1 and about 50% of the data allocated to the gate line GL5 may be allocated. To all the pixels connected to the gate lines GL4, the combined data of about 25% of the data allocated to the gate line GL1 and about 75% of the data allocated to the gate line GL5 may be allocated, for example. To all the pixels connected to the gate lines GL5, the data allocated to the gate line GL5 may be provided without a change (100%), for example.

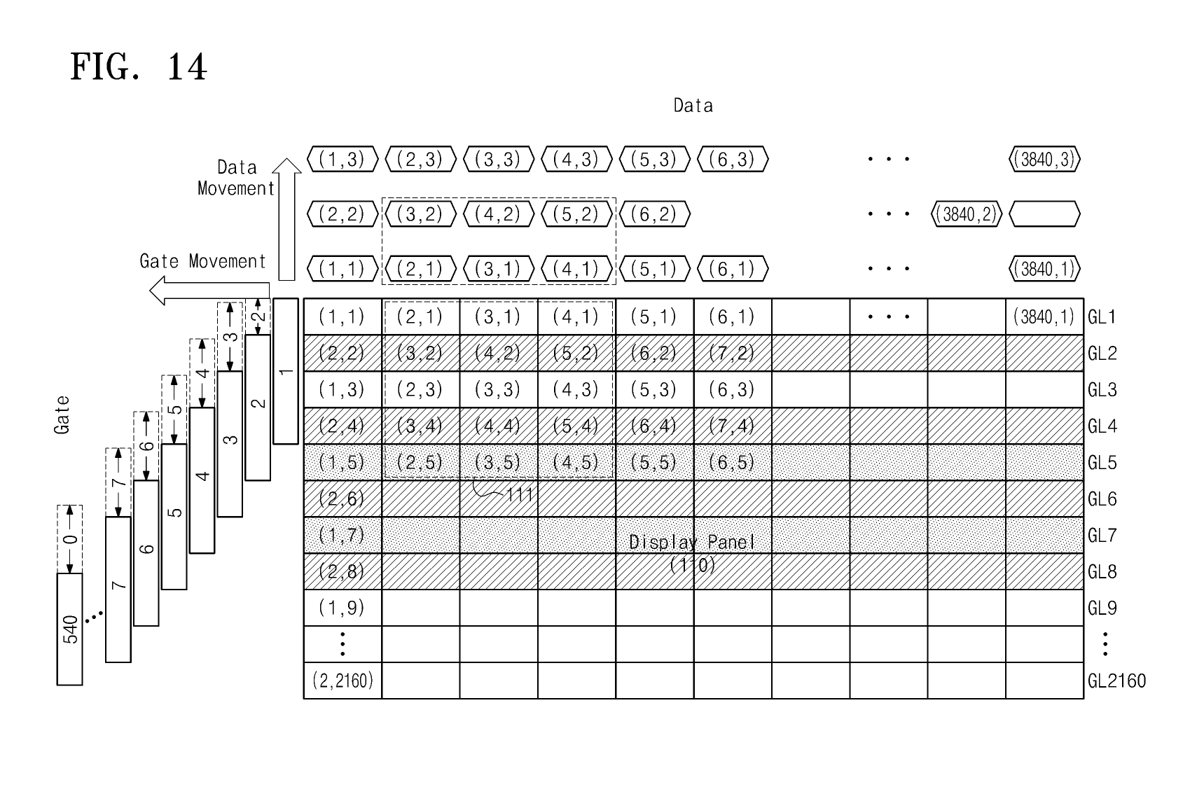

FIG. 14 is a view schematically illustrating a gate shift method and a data interpolation method according to another exemplary embodiment of the invention. Referring to FIG. 14, when a 3D image is realized, the gate lines allocated with the same data are respectively turned on sequentially at different times. Also, the linearly interpolated data allocated to the even-numbered gate lines or the odd-numbered gate lines may move one pixel to the left. For convenience of description, an example, in which the data allocated to the even-numbered gate lines moves to the left, is used.

First, the gate line GL1 is selected. Also, when the selected gate line GL1 is turned on, the data {(1,1), (2,1), (3,1), (4,0), . . . , (3840,1)} allocated to the gate line GL1 may be applied to the pixels connected to the gate line GL1. Next, when the gate-shifted gate line GL2 is turned on, the data {(2,2), (3,2), (4,2), (5,2), . . . , (3840,2), (X,X)}, which are linearly interpolated by about 75% with reference to each data of the gate lines GL1 and GL5 and are moved one pixel to the left, may be applied to the pixels connected to the gate line GL2, for example. Here, the data (X,X) may be provided as a dummy data.

Also, when the gate-shifted gate lines GL3 is turned on, the data {(1,3), (2,3), (3,3), (4,3), . . . , (3840,3)}, which are linearly interpolated by about 50%, may be applied to the pixels connected to the gate line GL3, for example. When the gate-shifted gate line GL4 is turned on, the data {(2,4), (3,4), (4,4), (5,4), . . . , (3840,4), (X,X)} which are linearly interpolated by about 75% and are moved one pixel to the left, may be also applied to the pixels connected to the gate line GL4. As a result, the gate shift, the data interpolation, and the movement, to the left, of the pixel data of the even-numbered gate lines may be simultaneously performed on the gate lines GL1 to GL4 allocated with the same data.

Next, when the gate line GL5 is turned on, the data {(1,5), (2,5), (3,5), (4,5), . . . , (3840,5)} allocated to the gate line GL5 may be applied to the pixels connected to the gate line GL5. Next, when the gate-shifted gate line GL6 is turned on, the data {(2,6), (3,6), (4,6), (5,6), . . . , (3840,6), (X,X)}, which are linearly interpolated by about 75% with reference to each data of the gate lines GL5 and GL9 and are moved one pixel to the left, may be applied to the pixels connected to the gate line GL6. Here, the data (X,X) may be provided as a dummy data.

Also, when the gate-shifted gate lines GL7 is turned on, the data {(1,7), (2,7), (3,7), (4,7), . . . , (3840,7)}, which are linearly interpolated by about 50%, may be applied to the pixels connected to the gate line GL7. When the gate-shifted gate line GL8 is turned on, the data {(2,8), (3,8), (4,8), (5,8), . . . , (3840,8), (X,X)} which are linearly interpolated by about 75% and are moved one pixel to the left, may be also applied to the pixels connected to the gate line GL8, for example. As a result, the gate shift, the data interpolation, and the movement, to the left, of the pixel data of the even-numbered gate lines may be simultaneously performed on the gate lines GL5 to GL8 allocated with the same data.

The gate shift, the linear interpolation, and the movement, to the left, of the pixel data of the even-numbered gate lines may also be sequentially applied to the remaining gate lines GL9 to GL2160 according to the same method.

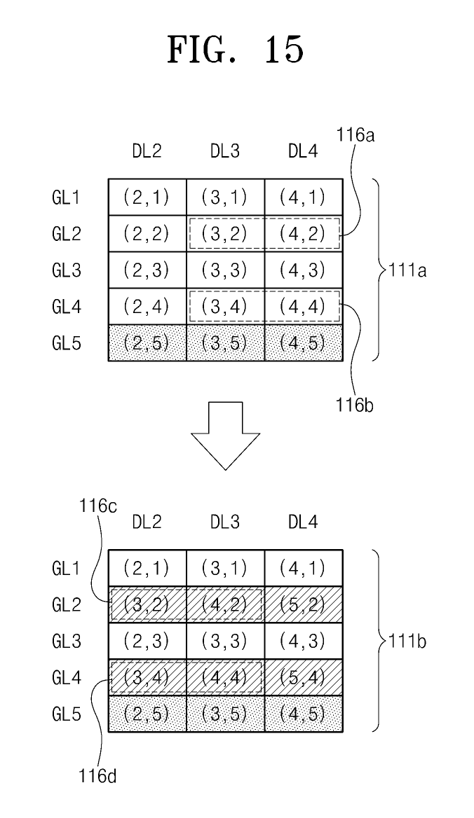

FIG. 15 is a view illustrating a data driving method for some pixels of FIG. 14. Referring to FIG. 15, the data, allocated to the pixels 111 (see FIG. 14) connected to the gate lines GL1 to GL5 and the data lines DL2 to DL4, are illustrated.

In the pixels 111a, the pixel data after the data interpolation, in which the data of adjacent gate lines are used, is completed, and before the movement to the right occurs are respectively illustrated. In an exemplary embodiment, the data allocated to the gate line GL1 may be provided without a change to all the pixels connected to the gate lines GL1 (100%), for example. To all the pixels connected to the gate lines GL2, the combined data of about 75% of the data allocated to the gate line GL1 and about 25% of the data allocated to the gate line GL5 may be allocated, for example. To all the pixels connected to the gate lines GL3, the combined data of about 50% of the data allocated to the gate line GL1 and about 50% of the data allocated to the gate line GL5 may be allocated, for example. To all the pixels connected to the gate lines GL4, the combined data of about 25% of the data allocated to the gate line GL1 and about 75% of the data allocated to the gate line GL5 may be allocated, for example. Also, to all the pixels connected to the gate line GL5, the data allocated to the gate line GL5 may be provided without a change (100%), for example.

In the pixels 111b, the pixel data, in which the pixel data of the even-numbered gate lines GL2 and GL4 are moved to the left, are respectively illustrated. In an exemplary embodiment, the allocated data may be provided, without a movement of the data to the left, to all the pixels connected to the gate lines GL1, GL3, and GL5. On the contrary, the pixel data of the even-numbered gate lines GL2 and GL4 are provided after being moved one pixel to the left. Such a data movement is shown as the pixel data 116a and 116b moving to the pixel data 116c and 116d.

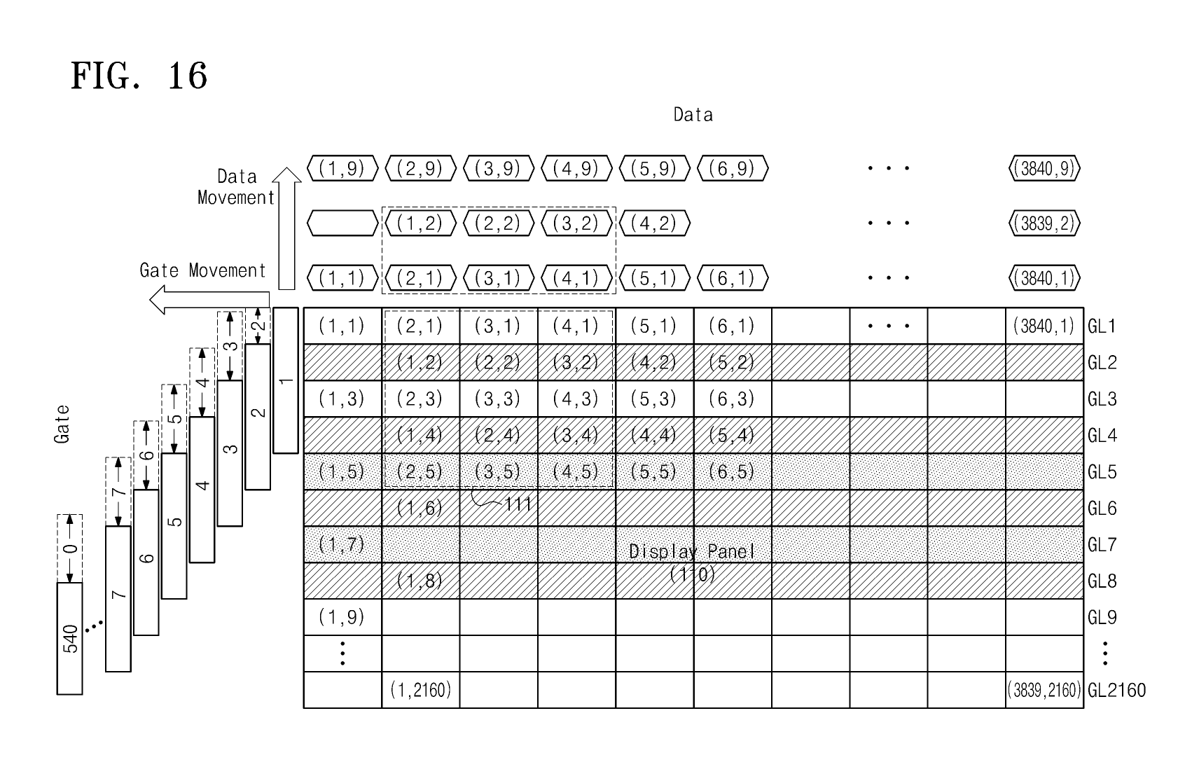

FIG. 16 is a view schematically illustrating a gate shift or a data interpolation method according to another exemplary embodiment of the invention. Referring to FIG. 16, when a 3D image is realized, the gate lines allocated with the same data are respectively turned on sequentially at different times. Also, the linearly interpolated data allocated to the even-numbered gate lines may move at least one pixel to the right.

First, the gate line GL1 is selected. Also, when the selected gate line GL1 is turned on, the data {(1,1), (2,1), (3,1), (4,0), . . . , (3840,1)} allocated to the gate line GL1 may be applied to the pixels connected to the gate line GL1. Next, when the gate-shifted gate line GL2 is turned on, the data {(X,X), (1,2), (2,2), (3,2), (4,2), (5,2), . . . , (3839,2)}, which are linearly interpolated by about 75% with reference to each data of the gate lines GL1 and GL5 and are moved one pixel to the right, may be applied to the pixels connected to the gate line GL2, for example. The data (X,X) may be provided as a dummy data.

Also, when the gate-shifted gate lines GL3 is turned on, the data {(1,3), (2,3), (3,3), (4,3), . . . , (3840,3)}, which are linearly interpolated by about 50%, may be applied to the pixels connected to the gate line GL3. When the gate-shifted gate line GL4 is turned on, the data {(X,X), (1,4), (2,4), (3,4), (4,4), . . . , (3839,4)}, which are linearly interpolated by about 75% and are moved one pixel to the right, may be also applied to the pixels connected to the gate line GL4, for example. As a result, the gate shift, the data interpolation, and the movement, to the right, of the pixel data of the even-numbered gate lines may be simultaneously performed on the gate lines GL1 to GL4 allocated with the same data.

Next, when the gate line GL5 is turned on, the data {(1,5), (2,5), (3,1), (4,5), . . . , (3840,5)} allocated to the gate line GL5 may be applied to the pixels connected to the gate line GL5. Next, when the gate-shifted gate line GL6 is turned on, the data {(X,X), (1,6), (2,6), (3,6), (4,6), (5,6), . . . , (3839,6)}, which are linearly interpolated by about 75% with reference to each data of the gate lines GL5 and GL9 and are moved one pixel to the right, may be applied to the pixels connected to the gate line GL6. The data (X,X) may be provided as a dummy data.

Also, when the gate-shifted gate lines GL7 is turned on, the data {(1,7), (2,7), (3,7), (4,7), . . . , (3840,7)}, which are linearly interpolated by about 50%, may be applied to the pixels connected to the gate line GL7, for example. When the gate-shifted gate line GL8 is turned on, the data {(X,X), (1,8), (2,8), (3,8), (4,8), . . . , (3839,8)}, which are linearly interpolated by about 75% and are moved one pixel to the right, may be also applied to the pixels connected to the gate line GL8, for example. As a result, the gate shift, the data interpolation, and the movement, to the right, of the pixel data of the even-numbered gate lines may be simultaneously performed on the gate lines GL5 to GL8 allocated with the same data.

The gate shift, the linear interpolation, and the movement, to the right, of the pixel data of the even-numbered gate lines which are applied to the gate lines GL5 to GL8 may also be sequentially applied to the remaining gate lines GL9 to GL2160 according to the same method.

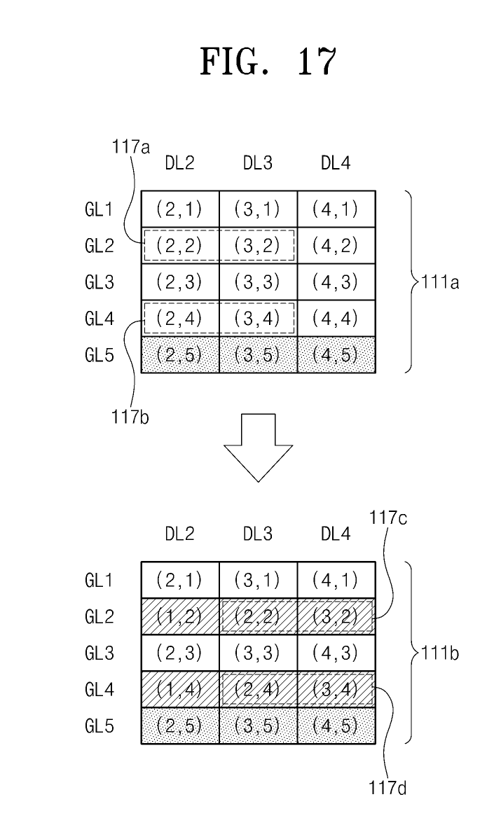

FIG. 17 is a view illustrating a data driving method for some pixels of FIG. 16. Referring to FIG. 17, the data, allocated to the pixels 111 (see FIG. 16) connected to the gate lines GL1 to GL5 and the data lines DL2 to DL4, are illustrated.

In the pixels 111a, the pixel data after the data interpolation, in which the data of adjacent gate lines are used, is completed, and before the movement to the right occurs are respectively illustrated. In an exemplary embodiment, the data allocated to the gate line GL1 may be provided without a change to all the pixels connected to the gate lines GL1 (100%), for example. To all the pixels connected to the gate lines GL2, the combined data of about 75% of the data allocated to the gate line GL1 and about 25% of the data allocated to the gate line GL5 may be allocated, for example. To all the pixels connected to the gate lines GL3, the combined data of about 50% of the data allocated to the gate line GL1 and about 50% of the data allocated to the gate line GL5 may be allocated, for example. To all the pixels connected to the gate lines GL4, the combined data of about 25% of the data allocated to the gate line GL1 and about 75% of the data allocated to the gate line GL5 may be allocated, for example. Also, to all the pixels connected to the gate line GL5, the data allocated to the gate line GL5 may be provided without a change (100%), for example.

In the pixels 111b, the pixel data, in which the pixel data of the even-numbered gate lines GL2 and GL4 are moved to the right, are respectively illustrated. In an exemplary embodiment, the allocated data may be provided without a movement of the data to all the pixels connected to the gate lines GL1, GL3, and GLS. On the contrary, the pixel data of the even-numbered gate lines GL2 and GL4 are provided after being moved one pixel to the right. Such a data movement is shown as the pixel data 117a and 117b moving to the pixel data 117c and 117d.

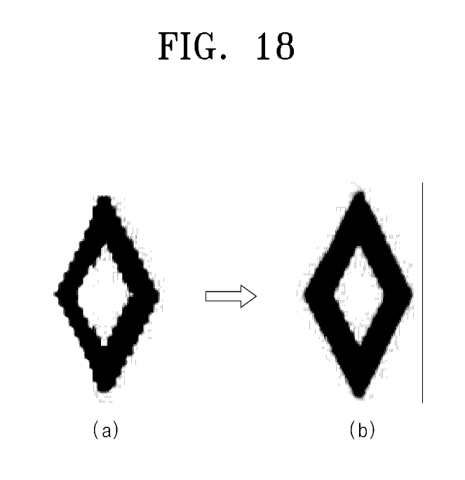

FIG. 18 is a view illustrating effects of the invention. Referring to FIG. 18, FIG. 18(a) is an image shown when four or more gate lines are simultaneously driven in the case where a 3D image is realized. FIG. 18(b) is an image shown when at least one among the gate shift, the linear interpolation, and the movement to the left or right of the pixel data according to the invention is applied. According to the data processing method of the invention, a decrease in resolution shown at the edge portion as illustrated in FIG. 18(a) may be solved. In addition, vertical moving lines may be removed through the gate shift or the movement of the pixel data in a row direction.

A display apparatus according to exemplary embodiments of the invention may improve display quality by solving vertical moving lines and resolution deterioration observed when displaying 3D images.

While exemplary embodiments are described above, a person skilled in the art may understand that many modifications and variations may be made without departing from the spirit and scope of the invention defined in the following claims. Also, exemplary embodiments disclosed in the invention are not intended to limit the technical spirit of the invention and the following claims and all technical spirits falling within equivalent scope are construed as being included in the scope of rights of the invention.

What is claimed is:

1. A display apparatus, which allocates a first data to a plurality of first gate lines, and allocates a second data to a plurality of second gate lines subsequent to the plurality of first gate lines, the display apparatus comprising:
a display panel including:
a plurality of pixels disposed on respective intersections where the plurality of first gate lines or the plurality of second gate lines cross a plurality of data lines;
a gate driver which turns on the plurality of first gate lines and the second gate lines in response to a gate control signal;
a data driver which transmits a data signal to the plurality of data lines in response to a data and a data control signal; and
a timing controller which generates the gate control signal such that a turn-on time of at least one first gate line of the plurality of first gate lines is shifted by a predetermined shift time, and provides the data and the data control signal such that a combined data of the first and second data is provided to the pixels connected to the at least one first gate line.

2. The display apparatus of claim 1, wherein the turn-on times of at least two first gate lines of the plurality of first gate lines are simultaneously shifted by the predetermined shift time.

3. The display apparatus of claim 2, wherein a combined data of the first data and the second data according to a same weight is provided to pixels connected to each of the at least two first gate lines.

4. The display apparatus of claim 1, wherein the plurality of first gate lines are turned on at different times, respectively, and from a turn-on time of a firstly selected first gate line of the plurality of first gate lines, remaining first gate lines of the plurality of first gate lines are turned on at respective times which are sequentially shifted.

5. The display apparatus of claim 4, wherein the first and second data are combined according to different weights and provided to the pixels connected to each of the plurality of first gate lines.

6. The display apparatus of claim 1, wherein the timing controller generates the gate control signal such that the predetermined shift time or the turn-on time of the at least one first gate line is adjusted according to a relative position on the display panel.

7. The display apparatus of claim 1, wherein the timing controller provides a pixel data provided to a first gate line of the at least one first gate line, adjacent to the plurality of second gate lines, after moving the pixel data to left or right by at least one pixel.

8. The display apparatus of claim 1, wherein the timing controller provides a pixel data provided to even-numbered first gate lines or odd-numbered first gate lines of the plurality of first second gate lines and even-numbered second gate lines or odd-numbered second gate lines of the plurality of second gate lines, after moving the pixel data to left or right by at least one pixel.

9. The display apparatus of claim 1, further comprising a memory which stores and provides, as a lookup table, the predetermined shift time for each of the plurality of first and second gate lines and combination weights of the first and second data for each of the plurality of first and second gate lines.

10. The display apparatus of claim 9, wherein the lookup table further comprises information for moving the pixel data to left or right by at least one pixel, the pixel data being provided to even-numbered first gate lines or odd-numbered first gate lines of the plurality of first gate lines and even-numbered second gate lines or odd-numbered second gate lines of the plurality of second gate lines.

11. The display apparatus of claim 10, wherein the timing controller activates an operation in which a turn-on time of the at least one of first gate line is shifted by the predetermined shift time in a three dimensional image display mode.
